(19) United States
(12) Patent Application Publication
(10) Pub. No.: US 2004/0158978 A1
(43) Pub. Date: Aug. 19, 2004

(54) Molding method and mold for encapsulating both sides of PCB module with wafer level package mounted PCB

(76) Inventors: Sang-Hyeop Lee, Cheonan-si (KR); Hee-Kook Choi, Cheonan-si (KR); Cheol-Joon Yoo, Cheonan-si (KR)

Correspondence Address: HARNESS, DICKEY & PIERCE, P.L.C., P.O. BOX 8910, RESTON, VA, 20195, US

(21) Appl. No.: 10/772,311

(22) Filed: Feb. 6, 2004

(30) Foreign Application Priority Data
Feb. 14, 2003 (KR) 2003-9361
May 16, 2003 (KR) 2003-31152

(51) Int. Cl. B29C 70/72; B29C 70/88

(52) U.S. Cl. 29/841; 264/272.17; 425/116

(57) ABSTRACT

Provided are a molding method for encapsulating in a substantially simultaneous manner wafer level packages (WLPs) arranged on opposite sides of a PCB module and a mold suitable for practicing the molding method. A PCB module is secured between an upper mold and a lower mold that cooperate to form a single mold. The upper mold includes an upper cavity for receiving an upper WLP and an upper gate through which an epoxy molding compound (EMC) may be forced into the upper cavity. The lower mold includes a lower cavity for receiving a lower WLP and a lower gate through which EMC may be forced into the lower cavity. The EMC may enter the gates through a single inlet formed between upper and lower inlet forming blocks, thereby encapsulating both the upper and lower sides of the PCB module substantially simultaneously, thereby improving productivity.

### CROSS-REFERENCE TO RELATED APPLICATIONS

This application claims priority from Korean Patent Application Nos. 2003-9361 and 2003-31152, filed on Feb. 14, 2003, and May 16, 2003, respectively, in the Korean Intellectual Property Office, the disclosures of which are incorporated herein by reference in their entirety.

### BACKGROUND OF THE INVENTION

1. Field of the Invention

The present invention relates to a molding method and a mold for encapsulating a printed circuit board (PCB) module with a wafer level package (WLP) mounted PCB. More particularly, the present invention relates to a molding method and a mold for encapsulating both sides of a PCB module including at least two WLP mounted on opposite sides of a PCB.

2. Description of the Related Art

Generally, a printed circuit board (PCB) module with a wafer level package (WLP) mounted PCB is encapsulated by molding using an epoxy molding compound (EMC) to reduce or prevent damage from external impacts. That is, in a PCB module having, for example, two WLPs mounted on respective upper and lower sides of a single PCB, the upper and lower sides of the PCB may be encapsulated by a molding formed from an EMC to reduce or prevent damage from external impacts.

A method for encapsulating a PCB module having one or more WLPs mounted on a PCB is illustrated in FIGS. 1-3 which provide cross-sectional views illustrating a conventional molding method. As illustrated in FIG. 1, WLPs 14 may be prepared from a semiconductor chip 10 by attaching multiple conductive bumps 12 to the lower side of the semiconductor chip 10 with the conductive bumps arranged to provide electrical contact between the semiconductor chip circuitry and a substrate on which the semiconductor chip will be mounted. Then, as illustrated in FIG. 2, two such WLPs 14 may be mounted on the upper and lower surfaces of a PCB 18 to prepare a PCB module 20.

Next, as illustrated in FIG. 3, the PCB module 20, in particular the upper WLP 14 and at least a portion of the upper surface of the PCB 18 may be placed in a cavity of a mold 22. Once the PCB module 20 is situated properly within the mold 22, an EMC 26 is forced into mold 22 through a gate 24 positioned at an outer side of the mold 22. That is, the EMC 26 is injected into the cavity of mold 22 through an inlet (as indicated by the arrow in FIG. 3) to surround and protect the upper portion of PCB module 20.

After completing the encapsulation of the upper side of the PCB module 20, the PCB module 20 is flipped over so that the lower side of the PCB module and the second WLP are placed in the mold 22. The lower side of the PCB module 20 is then encapsulated using an EMC (not shown) utilizing the same method illustrated in FIG. 3 with respect to the upper side of the PCB module. When utilizing the conventional molding method illustrated in FIG. 3 and described above, the upper and lower sides of the PCB module 20 are separately and sequentially encapsulated, thereby increasing the duration of the molding process and decreasing productivity.

### SUMMARY OF THE INVENTION

The present invention provides a molding method and a mold for encapsulating both sides of a PCB module with a least two WLPs mounted on the respective upper and lower sides of a PCB.

An exemplary embodiment of the present invention provides a molding method for encapsulating both sides of a PCB module, the molding method comprising: preparing two WLPs, each of which comprises a semiconductor chip and multiple conductive bumps attached to a lower side of the semiconductor chip; mounting the two WLPs on respective upper and lower portions of a PCB to prepare the PCB module; placing the PCB module between an upper mold and a lower mold, wherein the upper mold comprises an upper cavity that may be filled with an EMC that is introduced through an upper gate, and the lower mold comprises a lower cavity that may be filled with an EMC that is introduced through a lower gate; forcing an EMC into the upper and lower cavities from an inlet provided between upper and lower inlet forming blocks and through the upper and lower gates; separating an encapsulated PCB module from the upper and lower molds and the upper and lower inlet forming blocks; and removing a portion of the EMC corresponding to the inlet from the encapsulated PCB module.

The molding method may further comprise removing the EMC corresponding to the upper and lower gates from the encapsulated PCB module. The EMC corresponding to the upper and lower gates may be mechanically removed using a jig. When adhesive tapes or other film layers are bonded to upper and lower peripheral portions of the PCB corresponding to the respective upper and lower gates, the EMC corresponding to the upper and lower gates may be removed by removing the adhesive tape on which it was formed. A peripheral portion of the PCB corresponding to the upper and lower gates may be configured to have a thickness that is less than the thickness of other portions of the PCB.

Another embodiment of the present invention provides a mold for encapsulating both sides of a PCB module having two WLPs mounted on a PCB in which the mold comprises: an upper mold comprising an upper cavity for receiving at least one WLP mounted on an upper surface of the PCB; an upper gate through which EMC may be injected into the upper cavity; a lower mold comprising a lower cavity for receiving at least one WLP mounted on a lower surface of the PCB; and a lower gate through which EMC may be injected into the lower cavity. An exemplary embodiment of such a mold may further comprise upper and lower inlet forming blocks respectively positioned on an outer side of the upper mold and an outer side of the lower mold and contiguous with the upper gate and the lower gate for defining an inlet through which the EMC may be directed to the upper and lower gates.

The exemplary embodiments of the molding method according to the present invention thus provide for the substantially simultaneous encapsulation of both the upper side and the lower side of the PCB rather than the sequential encapsulation of the conventional molding methods, thereby improving the productivity of the encapsulating process.

### BRIEF DESCRIPTION OF THE DRAWINGS

The above and other features and advantages of the present invention will become more apparent through review of the detailed description provided below in which exemplary embodiments of the invention are described with reference to the attached drawings in which:

FIGS. 1-3 are sectional views illustrating a conventional molding method for encapsulating a PCB module having WLPs mounted on a PCB;

FIGS. 4-8 are sectional views illustrating a molding method for encapsulating both sides of a PCB module having WLPs mounted on a PCB according to an exemplary embodiment of the present invention;

FIGS. 9-11 are sectional views illustrating a molding method for encapsulating both sides of a PCB module having WLPs mounted on a PCB according to another exemplary embodiment of the present invention; and

FIGS. 12-15 are sectional views illustrating a molding method for encapsulating both sides of a PCB module having WLPs mounted on a PCB according to another exemplary embodiment of the present invention.

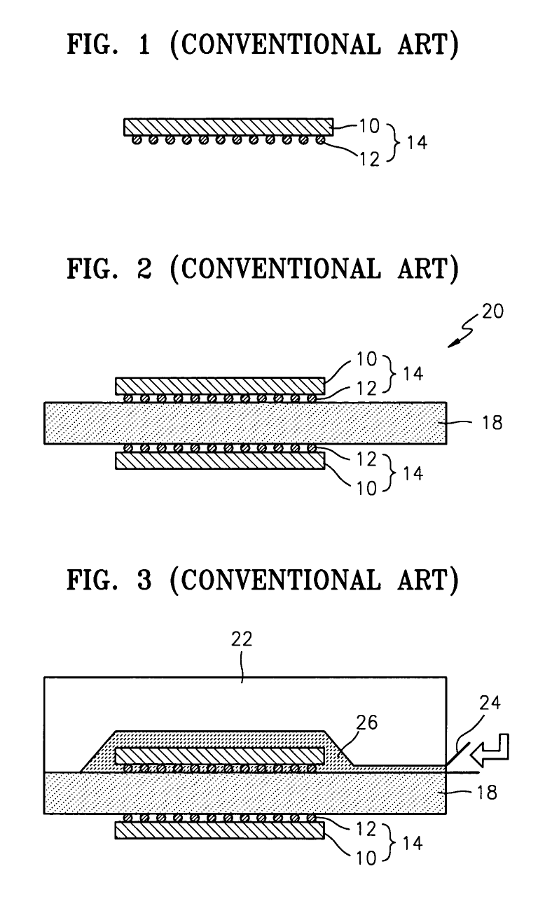

These drawings are provided for illustrative purposes only and are not drawn to scale. The spatial relationships and relative sizing of the elements illustrated in the various embodiments may have been reduced, expanded or rearranged to improve the clarity of the figure with respect to the corresponding description. The figures, therefore, should not be interpreted as accurately reflecting the relative sizing or positioning of the corresponding structural elements that could be encompassed by an actual device manufactured according to the exemplary embodiments of the invention. Further, identical reference numbers are used throughout the figures illustrating the various exemplary embodiments to designate identical, corresponding or similar elements or features.

### DETAILED DESCRIPTION OF EXEMPLARY EMBODIMENTS

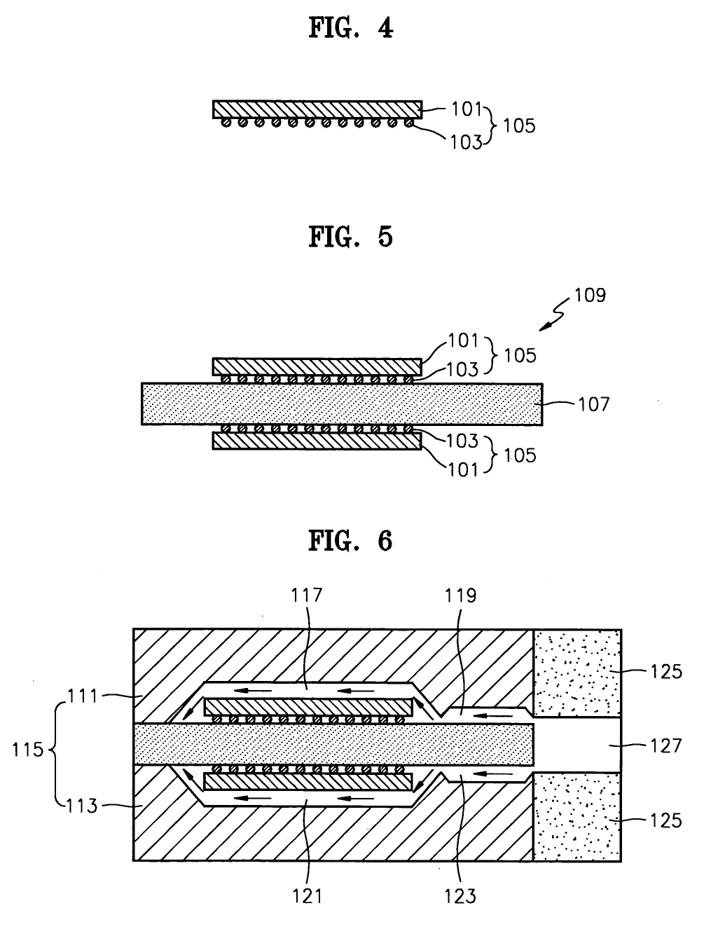

Hereinafter, exemplary embodiments of the present invention will be described in detail with reference to the accompanying drawings. FIGS. 4-8 are sectional views illustrating a molding method for encapsulating both sides of a printed circuit board (PCB) module that includes wafer level packages (WLPs) mounted on a PCB according to an exemplary embodiment of the present invention. In particular, FIGS. 6 and 7 show a mold that may be used in the molding method for encapsulating the both sides of the PCB module according to this embodiment.

As illustrated in FIGS. 4 and 5, WLPs 105, each of which includes a semiconductor chip 101 with multiple conductive bumps 103 arranged on a lower surface, FIG. 4, are respectively mounted on upper and lower portions of a PCB 107 to prepare a PCB module 109, FIG. 5. As illustrated in FIG. 6, the PCB module 109 is then placed in a mold 115 formed from an upper mold 111 and a lower mold 113.

The upper mold 111 includes an upper cavity 117 and an upper gate 119 for controlling entry of material such as EMC into the upper cavity. The lower mold 113 includes a lower cavity 121 and a lower gate 123 for controlling entry of material such as EMC into the lower cavity. Upper and lower inlet forming blocks 125 may be arranged adjacent the outer sides or surfaces of the corresponding upper and lower molds 111, 113 to form a passage or inlet 127 therebetween that is contiguous with the upper gate 119 and the lower gate 123.

As illustrated in FIG. 6, the PCB module 109 is placed between the upper mold 111 and the lower mold 113. In particular, the WLPs 105 are positioned within in the upper cavity 117 and lower cavity 119 respectively, with the mold cavities cooperating with the surfaces of the PCB 107 to form mold chambers surrounding the WLPs. Although, as annotated, FIG. 6 indicates that mold 115 is formed from only the upper mold 111 and the lower mold 113, it will be appreciated that the structural elements included in the mold are not so limited and may include, for instance, the inlet forming blocks 125 and/or other operative elements utilized to provide locking, pivoting, separating, moving, cooling or heating functions that cooperate to support a molding operation.

As illustrated in FIGS. 6 and 7 and indicated by the directional arrows in FIG. 6, an EMC 129 may be forced into the mold through the inlet 127, through the upper and lower gates 119, 123 and into the upper and lower cavities 117, 121 respectively. Preferably, a sufficient volume of EMC 129 is forced into the cavities 117, 121 to completely fill the cavities and under conditions sufficient to suppress the formation of voids, thereby encapsulating the WLP and a portion of the PCB surface within each cavity.

As illustrated in FIG. 8, after the EMC 129 is sufficiently set, which may be substantially immediately, the encapsulated PCB module may be removed from the upper mold 111, the lower mold 113, and the upper and lower inlet forming blocks 125. After being removed from the mold, the PCB module will typically be subjected to a deflashing or degating process during which the excess portions of the EMC 129, particularly those portions corresponding to the inlet formed between the upper and lower inlet forming blocks 125, the upper gate 119 and the lower gate 123, are removed to complete a PCB module package product 131. The excess EMC 129 may be removed from the encapsulated PCB module using various methods, including, for example placing the PCB module in a jig and removing the excess EMC by milling, media blasting or other direct mechanical processes.

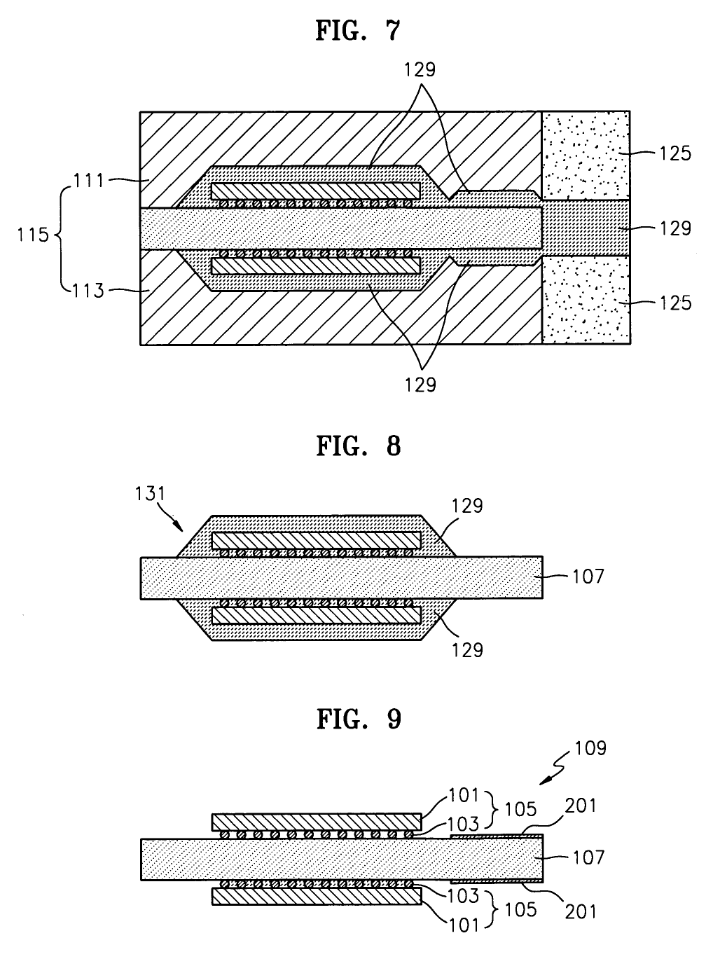

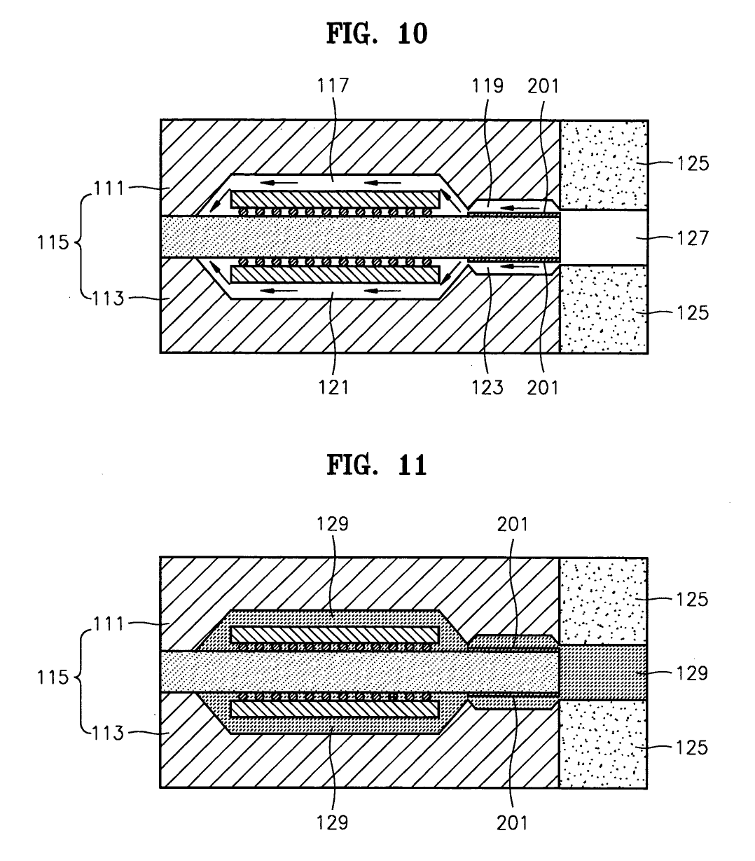

FIGS. 9-11 are sectional views illustrating another exemplary molding method for encapsulating both sides of a PCB module including WLPs mounted on a PCB according to the present invention. As illustrated in FIGS. 10 and 11, the molding components utilized in this exemplary embodiment correspond closely to the molding components illustrated in FIGS. 5 and 6 and described above. As illustrated in FIG. 9, WLPs 105, each of which includes a semiconductor chip 101 with multiple conductive bumps 103 arranged on a lower surface, are again respectively mounted on upper and lower portions of a PCB 107 to prepare a PCB module 109. In addition, adhesive tapes 201 are attached on upper and lower peripheral portions of the PCB 107 that correspond generally to the respective upper and lower gates 119 and 123.

As illustrated in FIG. 10, the PCB module 109, with adhesive tapes 201 attached to the upper and lower peripheral portions of the PCB, is then placed in a mold 115 that corresponds generally to the mold structure described previously in connection with FIGS. 6 and 7. In light of this correspondence, a detailed description of the mold 115 illustrated in FIGS. 10 and 11 will be omitted for the sake of simplicity.

As illustrated in FIG. 11, the EMC 129 is forced through the inlet 127 defined between the upper and lower inlet forming blocks 125 and through the upper gate 119 and lower gate 123 to fill the upper cavity 117 and the lower cavity 121 with EMC. After the EMC 129 is sufficiently set, the encapsulated PCB module may be separated from the upper mold 111, the lower mold 113, and the upper and lower inlet forming blocks 125. The excess EMC 129, again generally corresponding to the upper gate 119, lower gate 123 and typically inlet 129 may be removed by a degating process as described above to obtain a PCB module package product 131 as illustrated in FIG. 8. The EMC 129 of the encapsulated PCB module corresponding to the upper gate 119 and the lower gate 123 can then be removed using various methods. In this exemplary embodiment, as described above, the epoxy molding compound 129 of the encapsulated PCB module corresponding to the upper gate 119 and the lower gate 123 is removed with the removal of the underlying adhesive tapes 201.

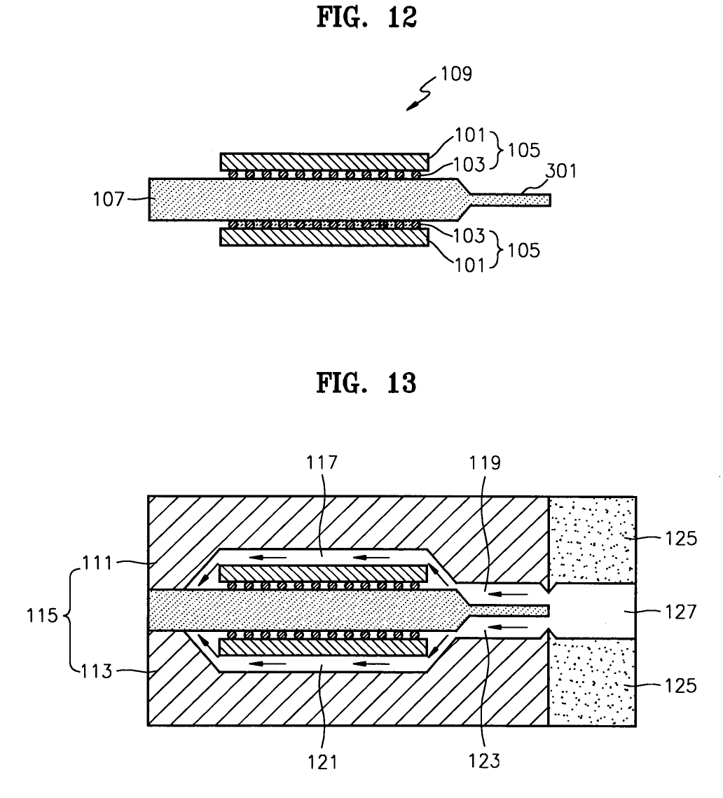

FIGS. 12-15 are sectional views illustrating another exemplary embodiment of a molding method for encapsulating both sides of a PCB module having WLPs mounted on opposite sides of a PCB according to the present invention. As illustrated in FIG. 12, at least two WLPs 105, each of which includes a semiconductor chip 101 with multiple conductive bumps 103 arranged on a lower surface, are again respectively mounted on upper and lower portions of a PCB 107 to prepare a PCB module 109. In addition, the thickness of a peripheral portion 301 of PCB 107 is reduced relative to the portions of the PCB utilized for mounting the WLPs.

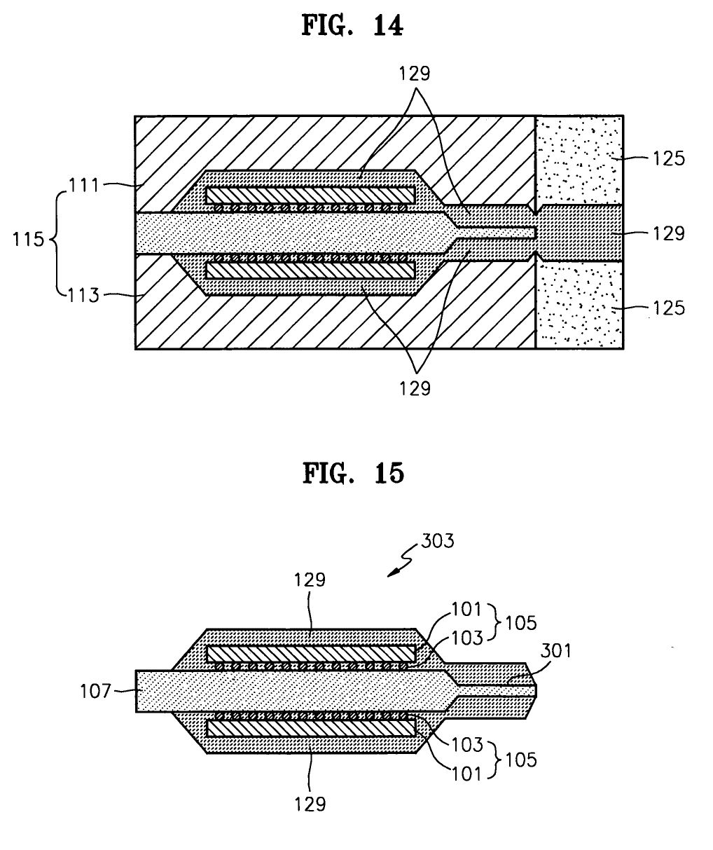

As illustrated in FIGS. 13 and 14, the PCB module 109 is then placed in a mold 115 that corresponds generally to the mold structure described previously in connection with FIGS. 6, 7, 10 and 11. In light of this correspondence, a detailed description of the mold 115 illustrated in FIGS. 13 and 14 will be omitted for the sake of simplicity. As illustrated in FIG. 13, the PCB module 109 is then oriented within the mold 115 so that the WLPs are positioned within the upper and lower mold cavities 117, 121 and the thinned peripheral portion 301 is directed toward the inlet 127 and positioned generally between the upper and lower gates 119, 123.

As illustrated in FIG. 14, the EMC 129 is then forced through the inlet 127 defined between the upper and lower inlet forming blocks 125, through the upper and lower gates, 119, 123, and into the upper and lower cavities 117, 121. The volume of EMC 129 is preferably sufficient to fill the cavities 117, 121 and encapsulate the WLPs positioned therein.

As illustrated in FIG. 15, once the EMC 129 has set sufficiently, the encapsulated PCB module may be removed from the mold 115 and excess EMC generally corresponding to the inlet 127 between the upper and lower inlet forming blocks 125 may be removed by a degating process as described above to obtain a PCB module package product 303. In particular, as illustrated in FIG. 15, in this exemplary embodiment EMC 129 remaining on the thinner peripheral portion 301 of the PCB 107 and corresponding to the upper and the lower gates 119, 123 is not removed. Depending on the configuration of the peripheral portion 301 of the PCB 107 and the upper and lower gate structures, the thickness of the portions of EMC 129 corresponding to the gate structures may be selected to obtain a PCB module 303 with substantially constant peripheral thickness, with or without requiring any additional milling of the peripheral portions of the EMC.

As is apparent from the above descriptions and associated figures, molding methods according to the exemplary embodiments of the present invention allow the upper and lower sides of a PCB module to be encapsulated simultaneously, thereby improving productivity when compared with the sequential processing of conventional methods for encapsulating WLPs arranged on opposite sides of a PCB.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A molding method for encapsulating both sides of a PCB module, the molding method comprising:
preparing a printed circuit board (PCB), the PCB having upper and lower surfaces;
preparing a first and a second wafer level package (WLP);
mounting the first WLP on the upper surface of the PCB and the second WLP on the lower surface of the PCB, thereby forming the PCB module;
placing the PCB module in a mold, the mold including an upper mold and a lower mold, wherein the upper mold includes an upper cavity that encloses the first WLP and an upper gate connected to the upper cavity, and the lower mold includes a lower cavity that encloses the second WLP and a lower gate connected to the lower cavity, and upper and lower inlet blocks defining an inlet connected to the upper gate and the lower gate;
forcing a volume of an epoxy mold compound (EMC) through the inlet into the upper and lower gates and through the upper gate into the upper cavity and through the lower gate into the lower cavity whereby the upper cavity and the lower cavity are filled with EMC substantially simultaneously;
setting the EMC in the upper and lower cavities, the upper and lower gates and the inlet to form an encapsulated PCB module;
separating the encapsulated PCB module from the mold; and
removing the EMC corresponding to the inlet from the encapsulated PCB module.

2. A molding method for encapsulating both sides of a PCB module according to claim 1, further comprising:
removing the EMC corresponding to the upper gate and the lower gate from the encapsulated PCB module.

3. A molding method for encapsulating both sides of a PCB module according to claim 1, wherein
removing the EMC corresponding to the inlet includes
placing the encapsulated PCB module in a jig and
mechanically removing the EMC corresponding to the inlet from the encapsulated PCB module.

4. A molding method for encapsulating both sides of a PCB module according to claim 2, wherein
removing the EMC corresponding to the upper gate and the lower gate includes
placing the encapsulated PCB module in a jig and
mechanically removing the EMC corresponding to the upper gate and the lower gate from the encapsulated PCB module.

5. A molding method for encapsulating both sides of a PCB module, the molding method comprising:
preparing a printed circuit board (PCB), the PCB having upper and lower primary surfaces;
attaching an upper film layer to a peripheral portion of the upper primary surface and a lower film layer to a peripheral portion of the lower primary surface;
preparing a first and a second wafer level package (WLP);
mounting the first WLP on the upper primary surface of the PCB and the second WLP on the lower primary surface of the PCB, thereby forming the PCB module;
placing the PCB module in a mold, the mold including an upper mold and a lower mold, wherein the upper mold includes an upper cavity that encloses the first WLP and an upper gate connected to the upper cavity, the upper gate arranged over the upper film layer, and the lower mold includes a lower cavity that encloses the second WLP and a lower gate connected to the lower cavity, the lower gate arranged over the lower film layer, and an inlet block defining an inlet connected to the upper gate and the lower gate;
forcing a volume of an epoxy mold compound (EMC) through the inlet into the upper and lower gates and through the upper gate into the upper cavity and through the lower gate into the lower cavity whereby the upper cavity and the lower cavity are filled with EMC substantially simultaneously;
setting the EMC in the upper and lower cavities, the upper and lower gates and the inlet to form an encapsulated PCB module;
separating the encapsulated PCB module from the mold; and
removing the EMC corresponding to the inlet from the encapsulated PCB module.

6. A molding method for encapsulating both sides of a PCB module according to claim 5, wherein:
the film layers are adhesive tapes.

7. A molding method for encapsulating both sides of a PCB module according to claim 5, further comprising:
removing the EMC corresponding to the upper gate and the lower gate from the encapsulated PCB module by removing the upper and lower film layers.

8. A molding method for encapsulating both sides of a PCB module according to claim 5, wherein
removing the EMC corresponding to the inlet includes
placing the encapsulated PCB module in a jig and
mechanically removing the EMC corresponding to the inlet from the encapsulated PCB module.

9. A molding method for encapsulating both sides of a PCB module according to claim 7, wherein
removing the EMC corresponding to the upper gate and the lower gate includes
placing the encapsulated PCB module in a jig and
mechanically removing the upper and lower film layers, thereby removing the EMC corresponding to the upper gate and the lower gate from the encapsulated PCB module.

10. A molding method for encapsulating both sides of a PCB module according to claim 1, wherein:
the PCB includes a main portion and a peripheral portion, the main portion having a thickness T₁ and the peripheral portion having a thickness T₂, the thicknesses T₁ and T₂ satisfying the relationship T₁>T₂; and
the upper gate and the lower gate are formed over the peripheral portion.

11. A molding method for encapsulating both sides of a PCB module according to claim 10, wherein:
the EMC in the upper gate has a thickness T^{U} and the EMC in the lower gate has a thickness T_{L}, and further wherein T₂+T_{U}+T_{L} is approximately equal to T₁.

12. A molding method for encapsulating both sides of a PCB module according to claim 12, wherein:
T_{U} and T_{L} are substantially equal.

13. A mold for encapsulating both sides of a PCB module with two wafer level packages mounted on a PCB, the mold comprising:
an upper mold including an upper cavity, the upper cavity arranged and configured for receiving at least one wafer level package (WLP) mounted on an upper surface of the PCB and an upper gate connected to the upper cavity through which an epoxy molding compound (EMC) may be forced into the upper cavity; and
a lower mold including a lower cavity, the lower cavity arranged and configured for receiving at least one WLP mounted on a lower surface of the PCB and a lower gate connected to the lower cavity through which an EMC may be forced into the lower cavity;
wherein the upper mold and lower mold cooperate to enclose the PCB module within the mold.

14. A mold for encapsulating both sides of a PCB module with two wafer level packages mounted on a PCB according to claim 13, further comprising:
upper and lower inlet forming blocks, wherein the upper inlet forming block may be positioned adjacent an outer side of the upper mold and the lower inlet forming block may be positioned adjacent an outer side of the lower mold, the inlet forming blocks cooperating to form an inlet through which EMC may be forced into both the upper gate and the lower gate.

15. A mold for encapsulating both sides of a PCB module with two wafer level packages mounted on a PCB according to claim 14, wherein:
the upper mold, lower mold, upper inlet forming block and lower inlet forming block are independently moveable.

16. A molding method for encapsulating both sides of a PCB module using a mold according to claim 14, the molding method comprising:
preparing the PCB module, the PCB module including a printed circuit board (PCB) having a first WLP mounted on an upper surface and a second WLP mounted on a lower surface;
placing the PCB module between the upper mold and a lower mold and closing the mold to seat the upper against the upper surface and seat the lower mold against the lower surface;
forcing a volume of an epoxy mold compound (EMC) through the inlet into the upper and lower gates and through the upper gate into the upper cavity and through the lower gate into the lower cavity whereby the upper cavity and the lower cavity are filled with EMC substantially simultaneously;
setting the EMC in the upper and lower cavities, the upper and lower gates and the inlet to form an encapsulated PCB module;
removing the encapsulated PCB module from the mold; and
removing excess EMC from the encapsulated PCB module.
